(19) United States
(12) Patent Application Publication
(10) Pub. No.: US 2008/0121136 A1
(43) Pub. Date: May 29, 2008

(54) Hybrid locomotive and method of operating the same

(75) Inventors: Jorge Mari, Muenchen (DE); Robert Roesner, Muenchen (DE)

Correspondence Address: GENERAL ELECTRIC COMPANY (PCPI);C/O FLETCHER YODER, P. O. BOX 692289, HOUSTON, TX, 77269-2289, US

(73) Assignee: General Electric Company

(21) Appl. No.: 11/605,022

(22) Filed: Nov. 28, 2006

(51) Int. Cl. B61C 7/04; B61C 5/00; B60M 3/00; B60M 3/06

(52) U.S. Cl. 105/35; 105/61.5; 105/62.1; 191/22 R; 303/151

(57) ABSTRACT

A hybrid locomotive includes at least one traction motor coupled to at least one of a plurality of axles and configured to drive at least one axle. A power converter is coupled to a main engine and to at least one traction motor and configured to supply electrical energy to the at least one traction motor and a secondary energy storage unit. A fuel storage unit is coupled to the main engine and configured to supply a gaseous fuel to the main engine. The main engine is adapted to burn gaseous fuel for reduced emissions, while maintaining excellent power output characteristics, that may be supplemented by secondary power sources.

### BACKGROUND

The invention relates generally to locomotives and, more particularly, a locomotive using natural or similar gases as their main engine fuel.

Conventional stand-alone locomotives have output power ranging from approximately 300 horsepower (for example, locomotives used in mining and tunneling) to 6000 horsepower (for example, locomotives for long haul cross-country freight trains). In many locomotive applications, especially ones in which there are significant grades along a route, a plurality of conventional stand-alone locomotives may be used to haul a large train composed of from a few to over one hundred cars. Conventional propulsion systems include fully-electric locomotives typically fed from an overhead line or diesel-hydraulic locomotives where the mechanical power generated by a diesel engine is adapted to the driven variable axle speed by means of a hydraulic transmission, gearing and other mechanical arrangements.

Certain other conventional railroad locomotives are typically powered by mixed or hybrid systems, such as a diesel-electric system. Such conventional locomotives may be used to capture and store energy that is otherwise wasted by incorporating an energy storage system (for example, battery pack, capacitor bank, flywheel assemblies, fuel cells, or a combination thereof). As a result, locomotive energy source is “hybrid” in nature. The energy storage system may be charged by an on-board engine, or another conventional hybrid or stand-alone locomotive, a regenerative braking system, or an external power source. The stored energy may be used to power the traction motors of the locomotive, auxiliary loads, or other cars of the train. Auxiliary loads may be referred to as for example, alternator blower, power electronics blower, traction motor blowers, compressed air unit, radiator fans, and other cooling equipment as well as smaller loads for lightning, battery back up, electronics control or the like.

However, there are drawbacks associated with the usage of oil-derived products such as diesel as a fuel for hybrid locomotives. For example, burning of diesel is associated with high levels of exhaust emissions, such as sulphur, particulates, nitrogen oxides, or the like, leading to environmental contamination. Additional equipment such as particulate filters may be required for after treatment of the exhaust gases to reduce environmental contamination. Moreover, because oil derivatives have greater densities than certain other fuels, locomotives transporting such fuels become heavier. Moreover, conventional hybrid locomotives are not adaptable to different load cycles and customer scenarios, such as freight switchers, passenger transport, or the like.

Accordingly, there is a need for a system that reduces emissions associated with combustion in hybrid locomotives. Also, there is a need for a system that reduces weight of the hybrid locomotive and is adaptable to different load cycles and customer scenarios.

### BRIEF DESCRIPTION

In accordance with one exemplary embodiment of the present invention, a hybrid locomotive includes at least one traction motor coupled to at least one of a plurality of axles and configured to drive at least one axle. An electrical power converter is coupled to an alternator which is coupled to a main engine and to the at least one traction motor and configured to supply electrical energy to the at least one traction motor. A fuel storage unit is coupled to the main engine and configured to supply a gaseous fuel to the main engine.

In accordance with another exemplary embodiment of the present invention, a hybrid locomotive includes at least one traction motor coupled to at least one of a plurality of axles and configured to drive at least one axle. A power converter is coupled to an alternator which is coupled to a lean-mixture internal combustion engine and to the at least one traction motor and configured to supply electrical energy to the at least one traction motor. A fuel storage unit is coupled to the lean-mixture internal combustion engine and configured to supply a gaseous fuel to the lean-mixture internal combustion engine.

In accordance with another exemplary embodiment of the present invention, a method for operating a hybrid locomotive includes supplying a gaseous fuel to a main engine. The main engine is operated to supply electrical energy via an alternator and a power converter to at least one traction motor. The at least one traction motor is operated to drive at least one of a plurality of axles.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of a hybrid locomotive using gas as a fuel for a main engine in accordance with an exemplary embodiment of the present invention;

FIG. 2 is a diagrammatical view of a hybrid locomotive having a secondary energy storage unit in accordance with the aspects of FIG. 1;

FIG. 3 is a diagrammatical view of a hybrid locomotive coupled to a third energy supply system, in this case an overhead railway line, in accordance with an exemplary embodiment of the present invention;

FIG. 4 is a diagrammatical view of a hybrid locomotive using gas as a fuel for two gas engines in accordance with an exemplary embodiment of the present invention;

FIG. 5 is a diagrammatical view of a hybrid locomotive using gas as a fuel for a main engine in accordance with an exemplary embodiment of the present invention;

FIG. 6 is a diagrammatical view of a hybrid locomotive using a lean mixture turbo charging technique in accordance with an exemplary embodiment of the present invention;

FIG. 7 is a diagrammatical view of a hybrid locomotive using a plurality of energy sources in accordance with an exemplary embodiment of the present invention; and

FIG. 8 is a flow chart illustrating exemplary steps involved in method of operating a hybrid locomotive in accordance with an exemplary embodiment of the present invention.

### DETAILED DESCRIPTION

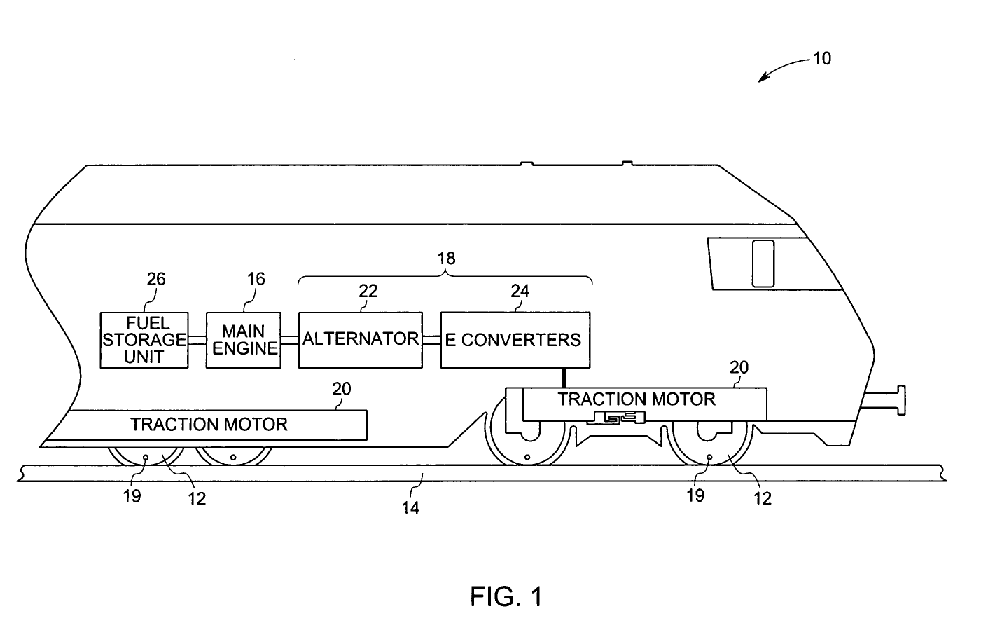

As discussed in detail below, embodiments of the present invention provide a hybrid locomotive including at least one traction motor coupled to at least one of a plurality of axles and configured to drive at least one axle. A power converter is coupled to a alternator of a main engine (e.g. a lean-mixture internal combustion engine) and to the at least one traction motor and configured to supply electrical energy to the at least one traction motor. A fuel storage unit is coupled to the main engine and configured to supply a gaseous fuel mixture to the main engine. In certain exemplary embodiments, fuel may be stored in the form of compressed gas, or liquefied gas, or adsorbed gas, or gas generated as a result of a previous chemical, or electrical, or mechanical, or thermal conversion. At least one secondary energy storage unit is configured to store and supply energy (after suitable adaptation) to the at least one traction motor, or auxiliary loads. The locomotive in accordance with the exemplary embodiments of the present invention is adaptable to different load cycles and customer scenarios, e.g. freight switchers, passengers trains, or the like. Properly operated gas engines may meet these objectives but cannot alone be used in standard locomotive regime (involving several full load swings per hour) without redesign inevitably including higher volume and weights. The system in accordance with the exemplary embodiments of the present invention, overcomes these problems in the hybrid version at the system level with little or no redesign of the internal combustion engine. The narrow positive operating range of the internal combustion engine (where high efficiency and low emissions are achieved) is extended by decoupling from the internal combustion engine the inconveniencies that variable speed and variable load represent. The secondary energy storage unit is used to account for the limitations of the main engine and secondary engines, to boost tractive effort and not merely as a means for storing braking energy. In certain embodiments, the secondary energy storage unit may be recharged during night, or during periodic maintenance conditions, or during low load conditions. Gas burning is also associated with reduced emissions, such as of particulates, nitrogen oxides, carbon dioxide, sulphur, or the like. In certain embodiments, the electric power from the secondary energy storage unit may be used for tractive effort inside stations, switch yards, in cities, or the like for controlling exhaust emissions and to reduce noise. Specific embodiments of the present invention are discussed below referring generally to FIGS. 1-8.

Referring to FIG. 1, an exemplary hybrid locomotive 10 in accordance with aspects of the present invention is illustrated. The illustrated hybrid locomotive 10 includes four sets of driving wheels 12 configured to move along a railway track 14. It should be noted that even though only four sets of driving wheels are illustrated; in certain other exemplary embodiments, the number of sets of driving wheels may vary. The locomotive 10 further includes a main engine 16, such as a gas turbine engine, or a spark ignition engine. One example of a gas engine may include a 4200-horse power, 16-cylinder, natural gas-fueled engine. The main engine 16 is configured to drive a power conversion unit 18 configured to convert the mechanical energy provided by the main engine 16 into a form acceptable to one or more traction motors 20 configured to drive a plurality of axles 19 coupled to the four sets of driving wheels 12. The motors 20 may include an AC induction motor, DC motor, permanent magnet motor or switched reluctance motor. The power conversion unit 18 may be an AC or DC type power conversion unit 18. In one exemplary embodiment, the power conversion unit 18 includes an alternator 22 and a power converter (rectifier) 24 configured to supply direct current (DC) to the traction motors 20. In another embodiment, the power conversion unit 18 transforms the alternating current from the alternator into alternating current of possibly varying frequency for the motors. The alternator may include a high-speed generator (e.g. especially suitable for gas turbine application), a generator machine whose stator flux is synchronous to the rotor flux, or an asynchronous machine.

In the illustrated embodiment, a fuel storage unit 26 is coupled to the main engine 16 and configured to supply a gaseous fuel to the main engine 16. The gaseous fuel may include natural gas (compressed or liquefied), biogas, hydrogen, propane, or a combination thereof stored in gaseous, or liquid, or solid form. The fuel storage unit 26 may include an on-board locomotive fuel storage unit, or a separate energy tender vehicle for fuel storage. It is known that diesel fuel burning is associated with relatively higher levels of emissions requiring extensive after treatment of exhaust gases. In accordance with the exemplary embodiments of the present invention, burning of gaseous fuel (e.g. through the use of a lean mixture) results in reduced exhaust emissions.

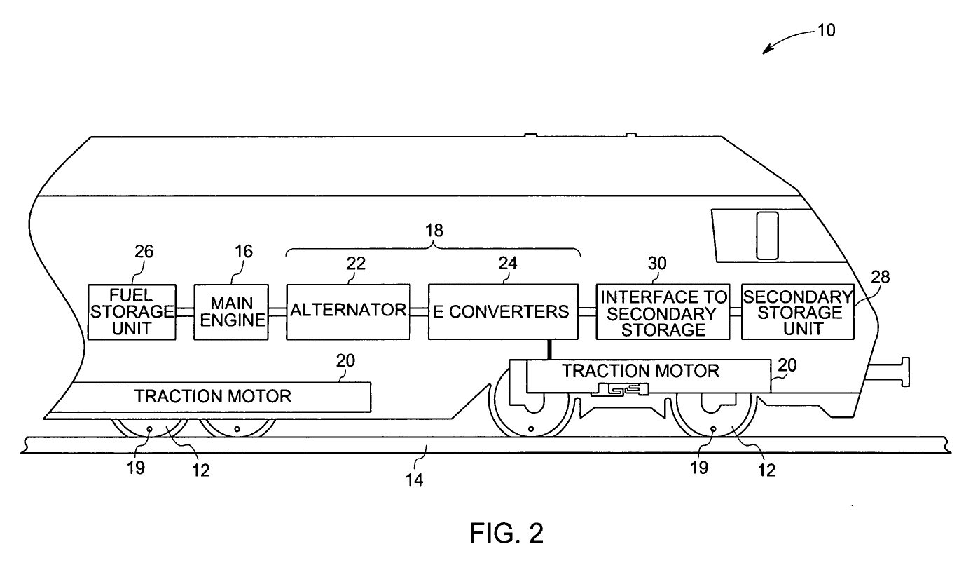

Referring to FIG. 2, the hybrid locomotive 10 is illustrated in accordance with certain alternative embodiments of the present invention. As discussed with reference to FIG. 1, the main engine 16 is configured to drive the power conversion unit 18 configured to convert the mechanical energy provided by the main engine 16 into a form acceptable to one or more traction motors 20 configured to drive a plurality of axles, 19 coupled to the four sets of driving wheels 12. In some embodiments, the power rating of the main engine is in the range of 100 to 2500 KW. In the illustrated embodiment, the power conversion unit 18 includes the alternator 22 and the power converter 24 (e.g. includes rectifier). A secondary energy storage unit 28 is coupled to the power converter 24 via an electrical interface 30. The secondary energy storage unit 28 is configured to store energy or supply electrical energy to drive the traction motors 20. It should be noted herein that in the illustrated embodiment and subsequent embodiments, the secondary energy storage unit 28 may be configured to drive “auxiliary loads”. The rating of the secondary energy storage unit 28 with reference to energy and power delivery capability is strongly dependent on the application. The rating of the secondary energy storage unit 28 may be biased towards high engine power for freight, long haul operations, and towards low engine-power extended storage for shunter operations. The secondary energy storage unit 28 in accordance with the embodiments of the present invention facilitates the variable load regime by decoupling it as much as possible from the main engine dynamic limitations. “Light hybrid” versions are also envisioned and will be described below. As an example, energy rating of storage unit 28 may be in the range of 100 to 1500 kW-hrs and power rating between 200 to 2000 kW. The secondary energy storage unit 28 may include a battery pack, a bank of capacitors, a compressed air storage system, a flywheel, fuel cells, or a combination thereof. The secondary energy storage unit 28 may be provided in wagons (e.g. passenger or freight cars). The combination of the main engine 16 and the secondary energy storage unit 28 are configured to address the varying traction power demands of the locomotive. The secondary energy storage is used to account for the power limitations of the main engine 16. It should be noted that the even though the embodiments of the present invention are described with reference to traction applications, the scope of the invention is not so limited, other variable load applications such as power generation in small grids and marine propulsion are also envisaged.

As discussed earlier, the fuel storage unit 26 is coupled to the main engine 16 and configured to supply a gaseous fuel mixture to the main engine 16. In one exemplary embodiment, the gaseous fuel may include liquid natural gas maintained at about −160 degrees Celsius. In another exemplary embodiment, the gaseous fuel includes a compressed natural gas maintained at ambient temperature and pressure range between 20 to 300 bars. In yet another exemplary embodiment, the gaseous fuel includes a liquefied petroleum gas such as butane or propane, and in particular embodiments the liquid petroleum gas is maintained at pressure of approximately 10 bars. In certain exemplary embodiments, the fuel storage unit 26 provided on board the locomotive is periodically refueled from fuel sources located on side of rail track. In certain other exemplary embodiments, the fuel storage unit is replaced in bulk, possibly with the help of truck lifters where the operator needs to connect the fuel storage unit to a gas pipeline system via a connection valve.

In certain exemplary embodiments, the main engine 16 is operated at variable speed and variable power load conditions. In certain other exemplary embodiments, the main engine 16 is operated at rated speed and rated power load conditions. The supply of electrical energy from the main engine 16 and the secondary energy storage unit 28 is varied depending on the load cycle. In one exemplary embodiment, for long distance applications, when the locomotive 10 is traveling at a speed less than or equal to a predetermined speed, electric power is fully supplied from the secondary energy storage unit 28 to the traction motors 20 to drive the wheels 12. The main engine 16 is shut off or in idling mode. When the locomotive is traveling at a speed greater than a predetermined speed, or, alternatively when the locomotive has reached a location along the way where emissions are of less concern (e.g. in the outskirts of a city, far away from urban train stations, or the like.), the electric power is fully supplied from the main engine 16 to the traction motors 20. Secondary storage recharging may occur during dynamic braking events or in advance if a path planner is available. In another exemplary embodiment, the main engine 16 supplies rated power (at rated speed) from the starting conditions of the locomotive, and the excess power (engine power minus traction power or auxiliary load power) from the main engine 16 may be used to recharge the secondary energy storage unit 28 during acceleration and deceleration conditions. The secondary energy storage unit 28 may be slowly charged during normal cruising conditions and may be charged faster during dynamic braking events. The secondary energy storage unit 28 may be fully recharged during dynamic braking conditions of the hybrid locomotive 10.

In certain other exemplary embodiments, the electric power from the secondary energy storage unit 28 is used to boost the tractive effort during starting conditions, high uphill gradients, and also heavy-haul conditions. In certain exemplary embodiments, for heavy-duty cycle applications such as in switchers, the main engine 16 is operated at full power conditions to drive traction motors 20 and recharge the secondary energy storage unit 28 continuously. The hybrid locomotive 10 in accordance with the embodiments of the present invention is adaptable to different load cycles and customer scenarios such as freight switchers, passenger trains, and heavy-haul applications.

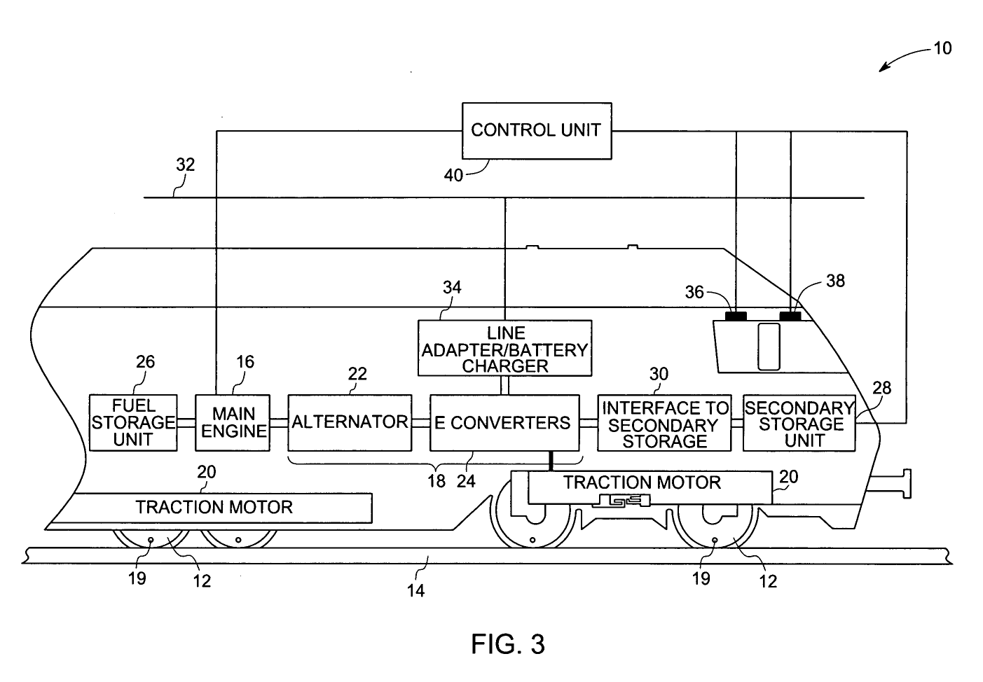

Referring to FIG. 3, the hybrid locomotive 10 is illustrated in accordance with certain further alternative embodiments of the present invention. As discussed with reference to FIG. 2, the power conversion unit 18 includes the alternator 22 and the power converter 24. The secondary energy storage unit 28 is coupled to the power converter 24 via the electrical interface 30. The secondary energy storage unit 28 is configured to store electrical energy or supply electrical energy to the traction motors 20. In the illustrated embodiment, an energy supply system 32 is adapted to be coupled to the power converter 24 via a line adapter/battery charger 34. The energy supply system 32 is configured to supply electrical power to the traction motors 20 and the secondary energy storage unit 28. The energy supply system 32 may include an overhead railway line, third rail, or an external industrial three-phase system, or a combination thereof. The energy supply system 32 may be coupled to the power converter 24 during standstill conditions in stations.

In the illustrated embodiment, the locomotive 10 includes a speed sensor 36 configured to detect speed of the main engine 16 and a power sensor 38 configured to detect power load of the main engine 16. A control unit 40 is configured to control speed and power load of the main engine 16 based on the output of the sensors 36, 38. The control unit 40 may also be used to control the power supply from the main engine 16 and the secondary energy storage unit 28 depending on the detected speed and power load. The control unit 40 may include a processor having hardware circuitry and/or software that facilitates the processing of signals from the sensors 36, 38. As will be appreciated by those skilled in the art, the processor may include a microprocessor, a programmable logic controller, a logic module or the like.

It should be noted herein that even though two sensors 36, 38 are illustrated, in certain other exemplary embodiments, the locomotive 10 may include a plurality of other sensors. For example, the locomotive 10 may include a variety of sensors to aid manage the power management in the system. The variety of sensors may include a locomotive track speed sensor employing velocity estimation from GPS position sensing and from averaging the traction motors or wheels speeds, one or gas flow sensors configured to detect the flow of gaseous fuel, a gas pressure gauge configured to detect pressure of gaseous fuel, a plurality of voltage sensors configured to detect DC-link voltage, secondary unit storage voltage, one or more current sensors configured to detect current through the alternator 22, the motors 20, and the secondary storage unit 28, one or more temperature sensors configured to detect temperature at the gas supply line, the main engine 16, the alternator 22, the power converter 24, the interface 30 to secondary storage unit, the secondary storage unit 28, and the motors 20. A state of charge estimator configured to detect the state of charge in the secondary storage unit 28 may also be employed.

In certain embodiments, the control unit 40 further includes a database, and an algorithm implemented as a computer program executed by the control unit computer or the processor. The database may be configured to store predefined information about the type of locomotive, speed and power conditions, type of gaseous fuel, type of engine, or the like. The database may also include instruction sets, maps, lookup tables, variables or the like. Such maps, lookup tables, and instruction sets, are operative to correlate characteristics of locomotive with the electric power requirements. The database may also be configured to store actual sensed or detected information pertaining to the speed and power load conditions. The algorithm may facilitate the processing of sensed information pertaining to the speed and power load conditions. Any of the above mentioned parameters may be selectively and/or dynamically adapted or altered relative to time. In one example, the control unit 42 is configured to update the above-mentioned predetermined speed threshold limit based on the load cycle and the customer scenarios. In another example, the control unit 42 is configured to update the proportioning of power from the main engine 16 and the secondary energy storage unit 28 based on the load cycle and the customer scenarios. Similarly any number of examples in which the parameters are altered are envisaged.

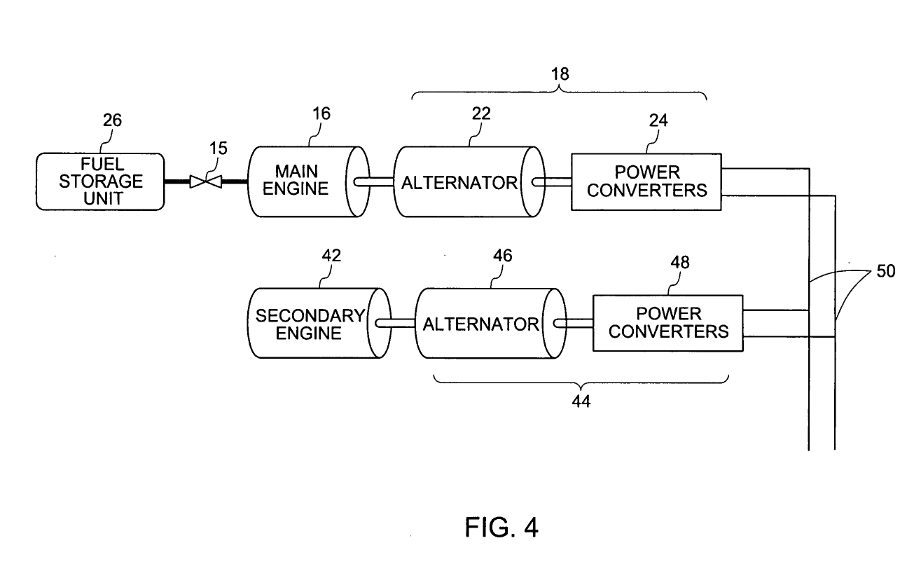

Referring to FIG. 4, a hybrid locomotive 10 in accordance with certain additional embodiments of the present invention is illustrated. In the illustrated embodiment, the locomotive 10 includes the main engine 16 configured to drive the power conversion unit 18. The power conversion unit 18 is configured to convert the mechanical energy provided by the main engine 16 into a form acceptable to one or more traction motors (DC or AC type) configured to drive the plurality of axles coupled to the driving wheels. In the illustrated exemplary embodiment, the power conversion unit 18 includes the alternator 22 and the power converter (rectifier) 24 configured to supply direct current (DC) to. the traction motors. The rectification of AC current from the alternator 22 may be performed with solid state switches provided as diodes (assembled in bridge configuration) or with controlled electronic switches as IGBTs (insulated gate bipolar transistors). In certain embodiments, the power converter 24 is configured to supply alternating current to the traction motors. In certain exemplary embodiments, the power converter 24 may be a cycloconverter, or a matrix converter (i.e. direct AC to AC conversion) for feeding power to AC motors. The fuel storage unit 26 is coupled to the main engine 16 and configured to supply a gaseous fuel to the main engine 16. In certain exemplary embodiments, an expansion valve 15 may be provided between the fuel storage unit 26 and the main engine 16 or the secondary engine 42. The expansion valve 15 is configured to expand gaseous fuel and the cooling effect due to expansion is used to cool subsystems such as power electronic equipments in the locomotive.

In the illustrated embodiment, the locomotive includes a secondary engine 42 configured to drive a secondary power conversion unit 44. It should be noted herein that even though one secondary engine is illustrated, in certain other exemplary embodiments, more than one secondary engine may also be used. The secondary engine 42 may be of a different type than the main engine 16. A separate gas supply line may be provided for the secondary engine 42. The secondary power conversion unit 44 is configured to convert the mechanical energy provided by the secondary engine 42 into a form acceptable to one or more traction motors. The secondary power conversion unit 44 includes an alternator 46 and a power converter 48 (e.g. includes rectifier) configured to supply direct current or alternating current (depending on the requirement) to the traction motors and possibly “auxiliary loads”. The engines 16, 42 are adapted to generate power to meet the traction and auxiliary power demands, by switching the secondary engine 42 on or off, or by operating at idle or partially load conditions, according to the requirements. The embodiment illustrated FIG. 4 is an enhancement over the embodiment illustrated in FIG. 1, since the locomotive 10 of FIG. 4 still has no secondary energy storage because the system facilitates the variable speed and variable load operation of the locomotives using and controlling the engines as required by the instantaneous power demand. In the illustrated embodiment of FIG. 4, the electric power from the main engine 16 and the secondary engine 42 is fed to a common DC link 50. The DC link may be a common DC link for all subsequent subsystems, or may be separate DC links for different subsequent subsystems. In certain exemplary embodiments, if the secondary engine 42 is also a gas burning engine, the fuel storage unit 26 is coupled to the secondary engine 42 and configured to supply a gaseous fuel to the secondary engine 42. In certain other exemplary embodiments, a separate gas supply line may also be provided to supply gaseous fuel to the secondary engine 42.

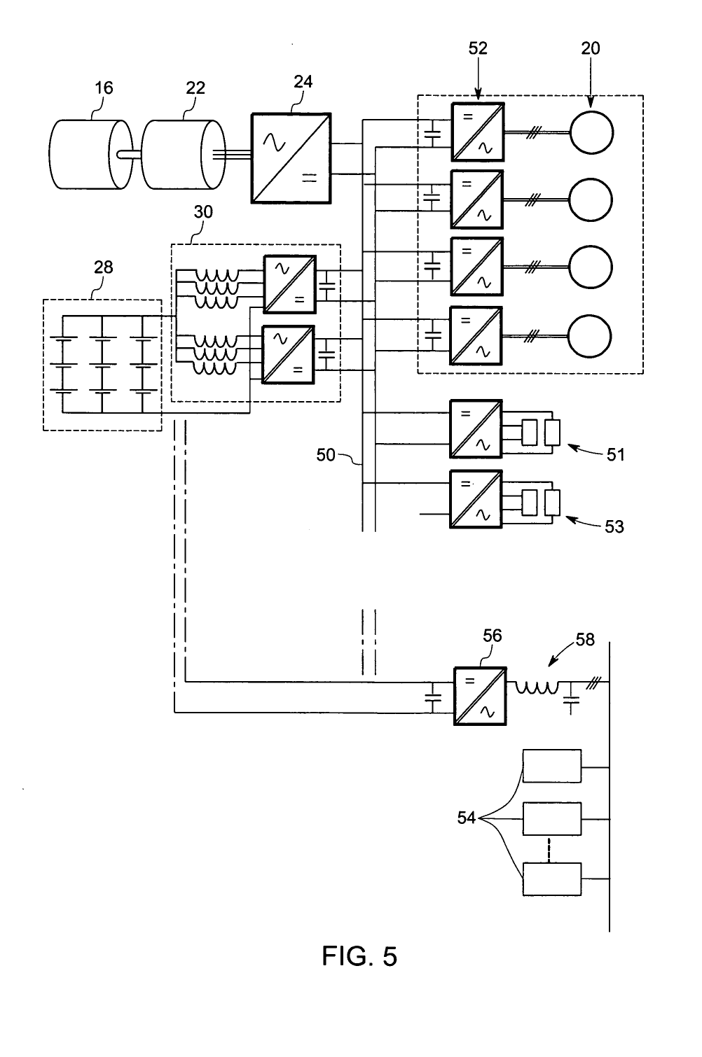

Referring to FIG. 5, the hybrid locomotive in accordance with certain other embodiments of the present invention is illustrated. In the illustrated embodiment, the locomotive 10 includes the main engine 16 configured to drive the power conversion unit 18. In the illustrated exemplary embodiment, the power conversion unit 18 includes the alternator 22 and the power converter (rectifier) 24 configured to supply direct current (DC) to the DC link 50. The DC link 50 is coupled to the traction motors 20 via a plurality of traction converters 52. It should be noted herein that even though four traction converters 52 are shown in the illustrated embodiment, in other exemplary embodiments, the number of traction converters may vary. Each traction converter 52 may be used to drive one or more AC traction motors. In the illustrated embodiment, one or more brake chopper arrangements 51, 53 are coupled (via traction converters 52 and interface 30) to the traction motors 20 and the secondary energy storage unit 28. In certain embodiments, the brake choppers 51, 53 and the secondary energy storage unit 28 are operated simultaneously to recharge the secondary energy storage unit 28 and dissipate excess power via the choppers 51, 53 during dynamic braking conditions. The chopper arrangements 51, 53 housed jointly or separately to the traction motor converters are also envisioned. The secondary energy storage unit 28 is coupled to the DC link 50 via the interface 30. The interface 30 includes a single or multiphase step up/step down chopper. The interface 30 facilitates to control the voltage at output of the secondary energy storage unit 28 and the DC link 50. A plurality of auxiliary loads 54 are coupled via an auxiliary power converter 56 and a 3-phase filter 58 to the DC link 50. The auxiliary power converter 56 is configured to convert the electrical energy into a form acceptable to the plurality of auxiliary loads 54. The auxiliary power converter 56 may be coupled to the DC link 50. In another exemplary embodiment, the auxiliary power converter 56 is directly coupled to a voltage interface of the secondary energy storage unit 28. In certain exemplary embodiments, the secondary energy storage unit 28 supplies power to the traction motors during heavy haul or high slope gradient conditions.

In the illustrated exemplary embodiment, auxiliary power is ensured to the locomotive irrespective of the functioning of the main engine 16. The rating of the secondary energy storage unit 28 may be reduced (compared to the main engine rated power) to maintain auxiliary load during periods when the engine is not operated. For freight and long haul operations, the ratings of the main engine 16, secondary energy storage unit 28, and the interface 30 are increased to higher levels of power. For shunting operations, the ratings of the main engine 16, secondary energy storage unit 28, and the interface 30 are reduced to lower levels of power. As a result, the locomotive is adaptable to varying load conditions.

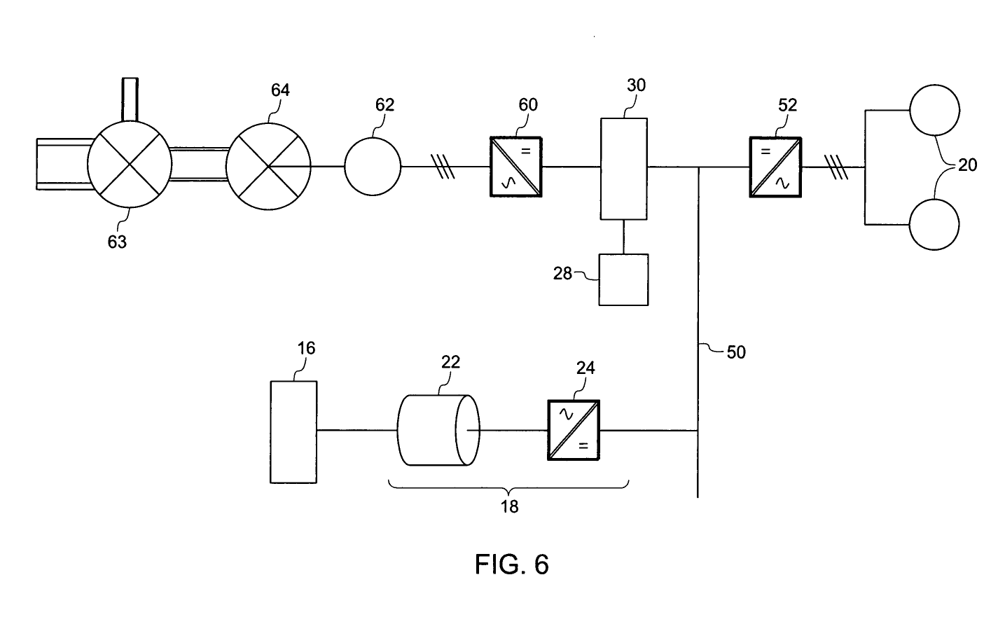

Referring to FIG. 6, the light hybrid locomotive in accordance with still further embodiments of the present invention is illustrated. In the illustrated embodiment, the locomotive 10 includes the main engine 16 (e.g. lean mixture internal combustion engine) configured to drive the power conversion unit 18. In the illustrated exemplary embodiment, the power conversion unit 18 includes the alternator 22 and the power converter (rectifier) 24 configured to supply direct current (DC) to the DC link 50. The DC link 50 is coupled to the traction motors 20 via the traction converter 52. The secondary energy storage unit 28 is coupled to the DC link 50 via the interface 30. In certain other exemplary embodiments, the secondary energy storage unit 28 is directly coupled to the DC link 50. In certain embodiments, during load transients, the power from the secondary energy storage unit 28 is supplied via a power converter 60 to an electric motor 62 configured to drive a turbocharger 64. The electric motor 62 may also be used to crank the main engine during starting operation conditions. The secondary energy storage unit 28, the power conversion unit 18, and electric motors 62 may be rated to match the turbocharger needs alone (as opposed to higher ratings for traction power back up). A lean mixture of air and fuel are compressed via the turbocharger 64 and fed to the main engine 16. The power from the secondary energy storage unit 28 facilitates to support variable load transients of the turbocharger 64. In certain embodiments, the turbocharger may be utilized to provide fuel to the combustion engine. In the illustrated embodiment, a mixing valve 63 is provided upstream of the turbocharger 64 configured to facilitate mixing of the air and gaseous fuel.

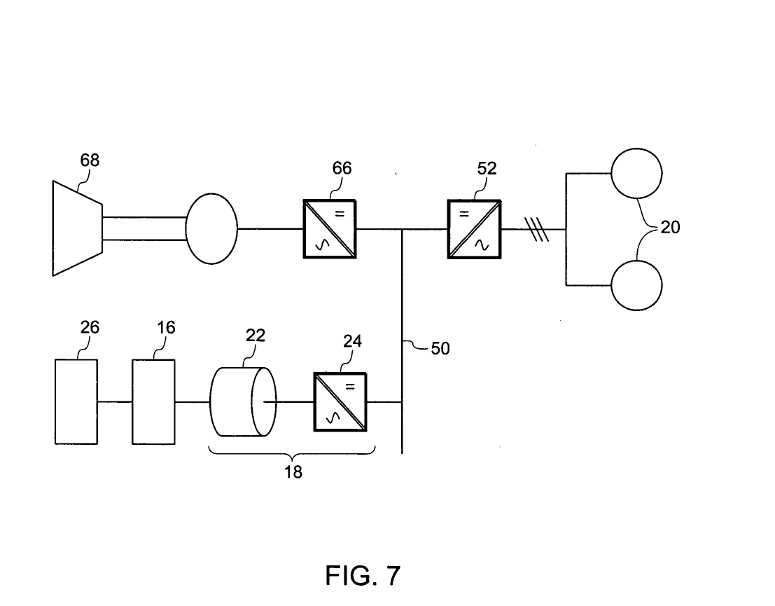

Referring to FIG. 7, the hybrid locomotive in accordance with yet another embodiment of the present invention is illustrated. In this embodiment, the locomotive 10 includes the main engine 16 configured to drive the power conversion unit 18. In the illustrated exemplary embodiment, the power conversion unit 18 includes the alternator 22 and the power converter (rectifier) 24 configured to supply direct current (DC) to the DC link 50. The DC link 50 is coupled to the traction motors 20 via the traction converter 52. The DC link 50 is also coupled via a power converter 66 to a turboexpander (turbine) 68. The gaseous fuel from the fuel storage unit or a closed-cycle gas line (not illustrated) is expanded via the turboexpander 68 and supplied to the main engine 16. The turboexpander 68 is configured to reduce the pressure of gaseous fuel from a higher pressure (e.g. 200 bar) to a lower pressure (less than 1 bar). The energy recovered via the turboexpander 68 may be utilized to drive auxiliary systems via one or more DC links and inverters. In certain other exemplary embodiments, an expansion valve may be used instead of the turboexpander 68 and the cooling effect during the gas expansion may be used to complement heat removal in other loco subsystems.

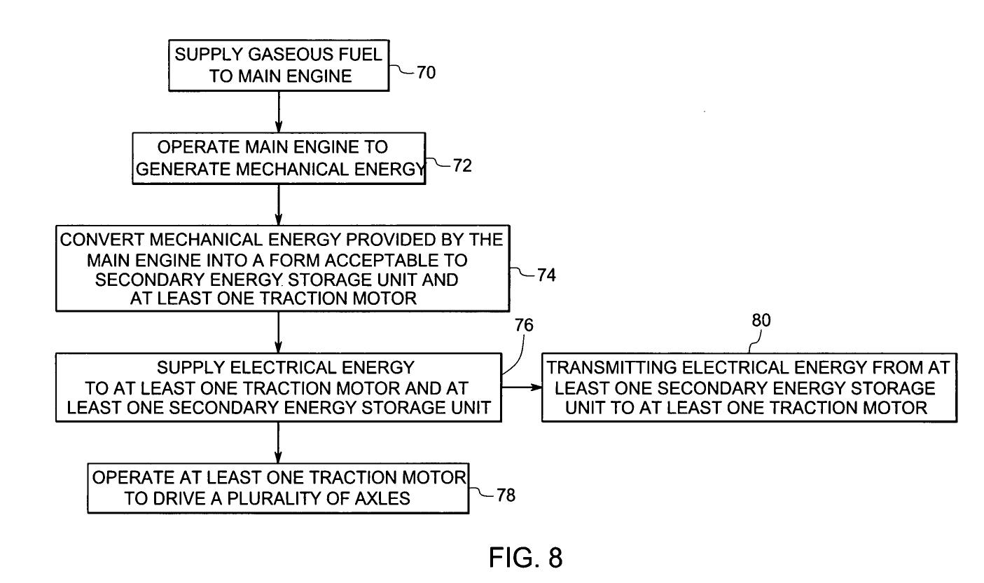

FIG. 8 is a flow chart illustrating exemplary steps involved in the method of operating a hybrid locomotive in accordance with the invention. The method includes supplying a gaseous fuel from a fuel storage unit to a main engine as represented by the step 70. The gaseous fuel may include natural gas, biogas, hydrogen, propane, or a combination thereof. The gaseous fuel may be supplied from an on-board locomotive fuel storage unit, or a separate energy tender vehicle. The main engine is operated to generate mechanical energy as represented by the step 72. The main engine drives a power conversion unit configured to convert the mechanical energy provided by the main engine into a form acceptable to one or more traction motors as represented by the step 74. In one exemplary embodiment, the power conversion unit supplies direct current to the traction motors. In another exemplary embodiment, the power conversion supplies alternating current to the traction motors. The traction motors are operated to drive a plurality of axles coupled to plurality of driving wheels of the locomotive.

The method further includes storing electrical energy in a secondary energy storage unit as represented by the step 76. In certain exemplary embodiments, electrical energy is stored in the secondary energy storage unit during dynamic braking. The secondary energy storage unit supplies stored electrical energy to the traction motors to drive plurality of axles coupled to the wheels. The combination of the main engine and the secondary energy storage unit facilitates to address the varying traction power demands of the locomotive. The secondary energy storage is used to account for the power limitations of the main engine.

In accordance with certain exemplary embodiments of the present invention, the combination of the gas-fueled main engine and the secondary energy storage unit are configured to address the varying traction power demands. The secondary energy storage unit accounts for limitations of the main engine. In certain exemplary embodiments, where two or more engines such as two gas engines are used, the main engine may be operated in a thermodynamically “open-cycle” configuration in which gas (fed from fuel storage unit) is combusted inside the main engine and exhausted to the atmosphere, whereas the secondary engine(s) may be operated in a thermodynamically “closed-cycle” configuration in which work is generated based on a pressure gradient. In certain other embodiments, the secondary engine may be operated in a thermodynamically “open-cycle” on board the locomotive.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A hybrid locomotive, comprising:
at least one traction motor coupled to at least one of a plurality of axles and configured to drive at least one axle;
a gaseous fuel burning main engine;
a power converter coupled to the main engine and to the at least one traction motor and configured to supply electrical energy to the at least one traction motor;
at least one secondary energy storage unit coupled to the power converter and configured to store and supply electrical energy; and
a fuel storage unit coupled to the main engine and configured to supply a gaseous fuel to the main engine.

2. The hybrid locomotive of claim 1, wherein the fuel comprises natural gas, biogas, hydrogen, propane, butane, or a combination thereof stored in gaseous, or liquid, or solid form.

3. The hybrid locomotive of claim 1, wherein the power converter is configured to convert the mechanical energy provided by the main engine into a form acceptable to the at least one traction motor.

4. The hybrid locomotive of claim 1, wherein the power converter is configured to convert the mechanical energy provided by the main engine into a form acceptable to one or more auxiliary loads.

5. The hybrid locomotive of claim 4, further comprising one or more brake choppers coupled to the traction motor and the secondary energy storage unit, wherein the brake choppers and the secondary energy storage unit are operated simultaneously to recharge the secondary energy storage unit and dissipate excess power via the brake choppers during dynamic braking.

6. The hybrid locomotive of claim 1, wherein at least one secondary energy storage unit is coupled to the power converter via an electrical interface.

7. The hybrid locomotive of claim 1, wherein at least one secondary energy storage unit is configured to store excess power from the main engine during acceleration and deceleration conditions of the locomotive, and to be charged during normal and dynamic braking operating conditions.

8. The hybrid locomotive of claim 1, further comprising an alternator coupled to the power converter and the main engine; wherein the alternator and the power converter are configured to supply direct current or alternating current to the at least one traction motor and the at least one secondary energy storage unit.

9. The hybrid locomotive of claim 1, further comprising one or more secondary engines, wherein the secondary engine is configured to supply power to the at least one traction motor and the at least one secondary energy storage unit.

10. The hybrid locomotive of claim 9, wherein the secondary engine comprises a turboexpander; wherein the secondary engine is operated in a thermodynamically open-cycle or in a thermodynamically closed-cycle configuration.

11. The hybrid locomotive of claim 1, wherein the main engine comprises a turbocharger, wherein the turbocharger is driven via an electric motor.

12. The hybrid locomotive of claim 11, wherein the secondary energy storage unit is configured to feed power to the electric motor.

13. The hybrid locomotive of claim 1, further comprises an expansion valve provided to the fuel storage unit and configured to expand the gaseous fuel, wherein the expanded gaseous fuel is configured to cool one or more locomotive subsystems.

14. The hybrid locomotive of claim 1, wherein the at least one traction motor comprises at least one DC motor.

15. The hybrid locomotive of claim 1, wherein the at least one traction motor comprises at least one AC motor.

16. The hybrid locomotive of claim 1, wherein the power converter is adapted to be coupled to an energy supply system configured to supply electrical energy to the at least one traction motor and the at least one secondary energy storage unit.

17. The hybrid locomotive of claim 16, wherein the energy supply system comprises an overhead railway line, third rail, or an external industrial three-phase system, or a combination thereof.

18. The hybrid locomotive of claim 1, wherein the at least one secondary energy storage unit comprises at least one of a battery pack, a bank of capacitors, a compressed air storage system, a flywheel, a fuel cell, or a combination thereof.

19. The hybrid locomotive of claim 1, wherein the main engine comprises a lean mixture internal combustion engine.

20. The hybrid locomotive of claim 1, wherein the main engine comprises a gas turbine engine.

21. A hybrid locomotive, comprising:
at least one traction motor coupled to at least one of a plurality of axles and configured to drive at least one axle;
a plurality of gaseous fuel driven engines;
at least one power converter coupled to the plurality of gaseous fuel driven engines and to the at least one traction motor and configured to supply electrical energy to the at least one traction motor; and
a fuel storage unit coupled to the main engine and configured to supply a gaseous fuel to the plurality of gaseous fuel driven engines.

22. The hybrid locomotive of claim 21, wherein the plurality of gaseous fuel driven engines comprises a main engine and at least one secondary engine.

23. The hybrid locomotive of claim 22, wherein the secondary engine is configured to overcome the transient limitations of the main engine.

24. The hybrid locomotive of claim 22, wherein the main engine is of a different type compared to the secondary engine.

25. The hybrid locomotive of claim 22, wherein power generated from the at least one secondary engine is adaptable to provide traction power and auxiliary power by switching the secondary engine on or off, operating at idle or partial load conditions.

26. The hybrid locomotive of claim 22, wherein the power converter is configured to convert the mechanical energy provided by the main engine into a form acceptable to the at least one traction motor.

27. The hybrid locomotive of claim 22, wherein the power converter is configured to convert the mechanical energy provided by the main engine into a form acceptable to one or more auxiliary loads.

28. The hybrid locomotive of claim 22, wherein the secondary engine comprises a turboexpander; wherein the secondary engine is operated in a thermodynamically open-cycle or closed cycle configuration on board the locomotive.

29. The hybrid locomotive of claim 28, wherein electrical energy generated via the turboexpander is adaptable to provide traction and auxiliary power.

30. A hybrid locomotive, comprising:
at least one traction motor coupled to at least one of a plurality of axles and configured to drive at least one axle;
a gaseous fuel burning lean mixture internal combustion engine;
a power converter coupled to the lean mixture internal combustion engine and to the at least one traction motor and configured to supply electrical energy to the at least one traction motor;
at least one secondary energy storage unit coupled to the power converter and configured to store and supply electrical energy; and
a fuel storage unit coupled to the lean mixture internal combustion engine and configured to supply a gaseous fuel to the lean mixture internal combustion engine.

31. The hybrid locomotive of claim 30, wherein the gaseous fuel comprises natural gas, biogas, hydrogen, propane, butane, or a combination thereof.

32. The hybrid locomotive of claim 30, wherein the power converter is configured to convert the electrical energy into a form acceptable to the at least one traction motor.

33. The hybrid locomotive of claim 30, wherein the at least one secondary energy storage unit is configured to store electrical energy, and supply electrical energy to the at least one traction motor; wherein the secondary energy storage unit is configured to overcome transient limitations of the lean mixture internal combustion engine.

34. The hybrid locomotive of claim 33, wherein the at least one secondary energy storage unit is configured to supply electrical energy to one or more auxiliary loads.

35. The hybrid locomotive of claim 33, wherein the at least one secondary energy storage unit is coupled to a DC link via an electrical interface, wherein the secondary energy storage unit supplies power to the traction motors during heavy haul or high slope gradient conditions.

36. The hybrid locomotive of claim 33, wherein the at least one secondary energy storage unit comprises at least one of a battery pack, a bank of capacitors, a compressed air storage system, a flywheel, fuel cells, or a combination thereof.

37. The hybrid locomotive of claim 33, further comprising a mixing valve provided to an upstream side of the turbocharger and configured to mix air and gaseous fuel.

38. A method for operating a hybrid locomotive, comprising:
supplying a gaseous fuel to a main engine;
operating the main engine to supply electrical energy via a power converter system to at least one traction motor;
storing or supplying electrical energy via at least one secondary energy storage unit; and
operating the at least one traction motor to drive at least one of a plurality of axles.

39. The method of claim 38, wherein supplying a gaseous fuel comprises supplying natural gas, biogas, hydrogen, propane, butane, or a combination thereof to the main engine.

40. The method of claim 38, comprising storing or supplying electrical energy to the at least one traction motor via at least one secondary energy storage unit.

41. The method of claim 40, comprising supplying electrical energy to one or more auxiliary loads via at least one secondary energy storage unit.

42. The method of claim 40, further comprising converting mechanical energy provided by the main engine into a form acceptable to the at least secondary energy storage unit and the at least one traction motor.

43. The method of claim 40, further comprising transmitting electrical energy between the at least one traction motor and the at least one secondary energy storage unit via an overhead railway line, or a third rail, or an external industrial three-phase system, or a combination thereof.

44. The method of claim 40, further comprising transmitting electrical energy from the at least one secondary energy storage unit to the at least one traction motor when the hybrid locomotive is traveling at a speed less than or equal to a predetermined speed.

45. The method of claim 44, further comprising using power from the secondary energy storage unit in addition to power from the main engine and one or more secondary engines to boost tractive effort of locomotive.

46. The method of claim 44, further comprising using power alone from the secondary energy storage unit for tractive effort inside stations, switch yards, and in cities for controlling exhaust emissions and noise.

47. The method of claim 44, further comprising transmitting electrical energy from the main engine to the at least one traction motor when the hybrid locomotive is traveling at a speed in excess of a predetermined speed.

48. A method for operating a hybrid locomotive, comprising:
supplying a gaseous fuel to a plurality of gaseous fuel driven engines;
operating the plurality of gaseous fuel driven engines to supply electrical energy via a power converter system to at least one traction motor; and
operating the at least one traction motor to drive at least one of a plurality of axles.

49. The method of claim 48, wherein operating the plurality of gaseous fuel driven engines comprises operating a main engine and at least one secondary engine to supply electrical energy via the power converter system to at least one electrical motor.

50. The method of claim 49, further comprising converting the mechanical energy provided by the main engine into a form acceptable to the at least one traction motor via the power converter.

51. The method of claim 50, further comprising converting the mechanical energy provided by the main engine into a form acceptable to one or more auxiliary loads via the power converter.
